(19) United States
(12) Patent Application Publication
(10) Pub. No.: US 2013/0014875 A1
(43) Pub. Date: Jan. 17, 2013

(54) RUN FLAT TIRE AND SYSTEM

(71) Applicant: Khaled Khatib, Lewiston, NY (US)

(72) Inventor: Khaled Khatib, Lewiston, NY (US)

(73) Assignee: HUTCHINSON INDUSTRIES, INC., Trenton, NJ (US)

(21) Appl. No.: 13/504,347

(22) PCT Filed: Dec. 21, 2009
(86) PCT No.: PCT/US09/68930

§ 371 Date: Apr. 26, 2012

Related U.S. Application Data
(60) Provisional application No. 61/247,074, filed on Sep. 30, 2009.

(51) Int. Cl. B60C 17/00; B21D 53/26

(52) U.S. Cl. 152/516; 29/894.3

(57) ABSTRACT

The present invention provides a run flat tire and system adapted for alignment around a wheel and inside a tire. The run flat tire and system comprises one or more arcuate portions configured and arranged so as to be releasably aligned and connected to form a run flat device suitable for installation around a tire rim drop center. The invention further comprises one or more insert or encapsulated portions (corresponding to one or more arcuate portions) made of a relatively strong or stiff material, and one or more corresponding outer portions of a relatively soft or lower durometer material. In one aspect, outer portion(s) are molded around or directly on corresponding encapsulated portion(s).

### PRIORITY CLAIM

The present application claims priority to Provisional Patent Application No. 61/247,074, filed Sep. 30, 2009, incorporated herein by reference.

### BACKGROUND OF THE INVENTION

Run flat tire systems are used on automobiles, commercial vehicles and military vehicles, among others, to provide for continued operation of vehicles (often at reduced speeds and for limited distances) after a tire blow out, reduced tire pressure or other tire damage. Generally, run flat tire systems consist of a support ring or toroid disposed within a rubber tire and attached to or aligned around a wheel.

### BRIEF SUMMARY OF THE INVENTION

With parenthetical reference to the corresponding parts, portions or surfaces of the disclosed embodiments, merely for purposes of illustration and not by way of limitation, the present invention provides a run flat system comprising one or more arcuate portions (200, 210, 220, 300, 310, 320) configured so as to extend radially outward from a wheel. Where two or more arcuate portions are used, they are configured and arranged so as to connect or join together to form a ring or toroid. One or more of said arcuate portions comprise an insert portion (201, 211, 221, 301, 311, 321) of relatively stiff or strong material (e.g. of a higher durometer or stiffness or greater strength than other parts or portions of the arcuate portion(s)). In one aspect, the insert portion is encapsulated by (in whole or in part) an outer portion (202, 212, 222, 302, 312, 322) of material which is relatively soft or which has less strength or stiffness, or lower durometer.

In one aspect, said arcuate portion(s) have apertures at a proximal end and a distal end, whereby a distal end aperture in a first arcuate portion may be aligned with an aperture in a proximal end of a second arcuate portion, whereby the arcuate portions may be joined or connected.

In one aspect, the run flat tire and system has a plurality of load bearing arcuate portions configured so as to extend radially outward from a wheel, wherein each of the arcuate portions is releasably secured to at least one other arcuate portion, and all arcuate portions are secured together to form a continuous ring or attachment around the wheel; and wherein at least one of the arcuate portions comprises an insert or encapsulated portion wholly or partially within, or surrounded or encompassed by an outer portion, wherein the insert portion is made from a material having a higher strength, durometer or stiffness than the outer portion. In another aspect, the outer portion is molded onto the insert portion.

In another aspect, the run flat tire and system has a plurality of load bearing arcuate portions configured so as to extend radially outward from the drop center of a wheel wherein each of the arcuate portions is releasably secured to at least one other arcuate portion, and all arcuate portions are secured together to form a continuous ring for attachment around the wheel drop center; wherein the outer surfaces of the arcuate portions are made from a polyester elastomer thermoplastic resin or similar material. In another aspect, the outer surface of an arcuate portion surrounds, wholly or partly, a corresponding insert portion, which insert portion has greater strength, hardness or stiffness than the outer surface, which insert portion may be made of reinforced polyamide 66 resin, polybutylene terephthalate resin or a similar material, and/or made of steel such as 4140 steel.

### BRIEF DESCRIPTION OF DRAWINGS

FIG. 1 is an illustration of a side view of a three-segment run-flat tire.

FIG. 2 is a cross-sectional view of a portion of the run-flat tire illustrated in FIG. 1.

FIG. 3 is a perspective view of the run-flat tire illustrated in FIG. 1.

FIG. 4 is a perspective view of a connection between two arcuate sections in the run-flat tire illustrated in FIG. 1.

FIG. 5 is an illustration of a run-flat tire as used with an inflated tire.

FIG. 6 is an illustration of a run-flat tire as used with a deflated tire.

FIG. 7 is a perspective view of a run flat tire, a wheel and a tire.

FIG. 8 is a side view of a run-flat tire, a wheel and a tire.

FIG. 9 is a cross-sectional view of the run-flat tire illustrated in FIG. 8.

FIG. 10 is a cross-sectional view of the run-flat tire illustrated in FIG. 8, with a deflated tire.

FIG. 11 is an expanded view of the top portion of the run-flat tire illustrated in FIG. 9.

FIG. 12 is an expanded view of components of a connection mechanism of the run-flat tire illustrated in FIG. 1.

FIG. 13 is a perspective view of a run-flat tire wherein three arcuate sections are illustrated independently.

FIG. 14 is a side view of a run-flat tire.

FIG. 15 is a side view of a segment of a run flat tire.

FIG. 16 is a cross-sectional view of the run flat tire segment illustrated in FIG. 15, illustrating an insert portion.

FIG. 17 is a different side view of the run flat tire segment of FIG. 15.

FIG. 18 is a cross-sectional view of the run flat tire segment illustrated in FIG. 17, illustrating an insert portion.

FIG. 19 is a perspective view of a three-segment run flat tire, with an insert portion in solid lines.

FIG. 20 is a perspective view of a three-segment run flat tire, with an insert portion in solid lines.

FIG. 21 is a perspective view of a three-segment run flat tire, with an insert portion in dashed lines.

### DESCRIPTION OF THE PREFERRED EMBODIMENTS

At the outset, it should be clearly understood that like reference numerals are intended to identify the same parts, elements or portions consistently throughout the several drawing figures, as such parts, elements or portions may be further described or explained by the entire written specification, of which this detailed description is an integral part. The following description of the preferred embodiments of the present invention are exemplary in nature and are not intended to restrict the scope of the present invention, the manner in which the various aspects of this invention may be implemented, or their applications or uses.

A preferred embodiment of the run flat tire system and device comprises one or more arcuate run flat portions 200, 210, 220, 300, 310, 320 (also referred to as arcuate sections, members or segments) assembled around a wheel or rim drop center. The arcuate portions are connected, secured or fastened together with nuts and bolts, or by other hardware. In a preferred embodiment, corresponding apertures in adjacent arcuate portions are aligned, and such hardware or other mechanism(s) are used to join or connect adjacent portions through the apertures. One embodiment of the invention is a lightweight design with a bead retainer for operating with high performance vehicles among others.

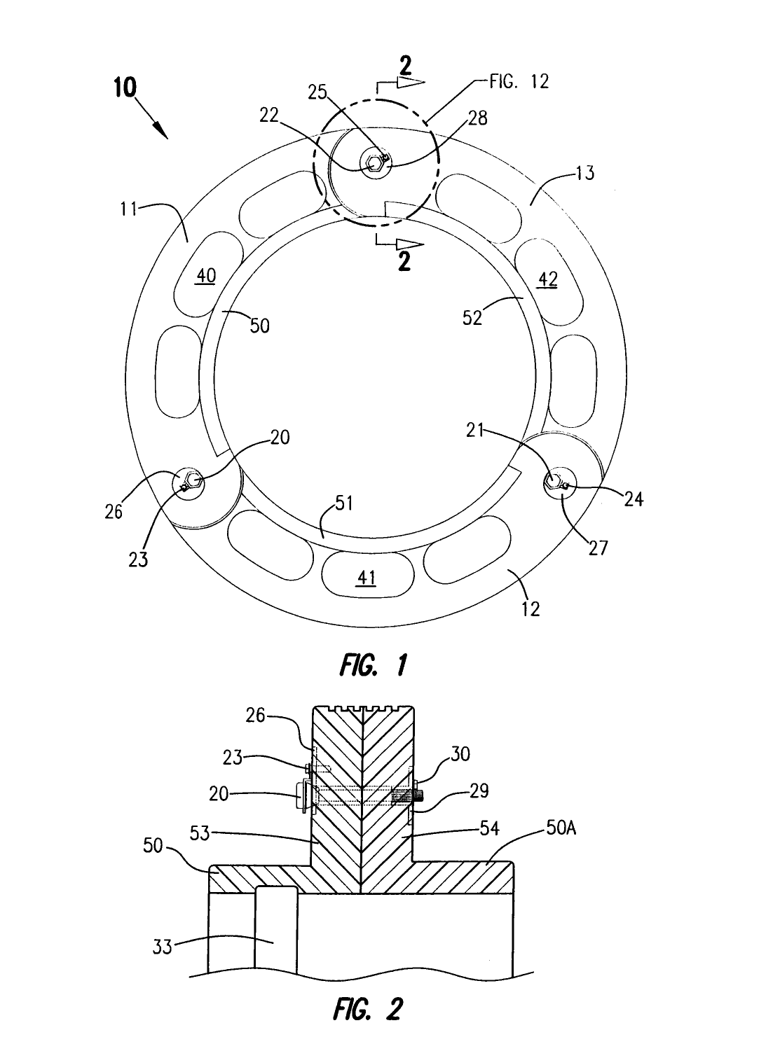

Referring now to the drawings, FIG. 1 is a side view of a run flat device 10. In this embodiment, three arcuate sections 11, 12, 13 are connected with nuts, bolts 20, 21, 22, screws 23, 24, 25 and offset or recessed washers 26, 27, 28, which arcuate sections are releasably aligned and connected to form a run flat device suitable for installation around a tire rim drop center. FIG. 1 also illustrates extended lip or flange portions 50, 51, 52 which extend laterally from the base of each of the arcuate sections 11, 12, 13, and depressions 40, 41, 42 in each of the arcuate sections. The invention is not limited to a run flat tire having three sections as illustrated, but may have two sections or more than three sections.

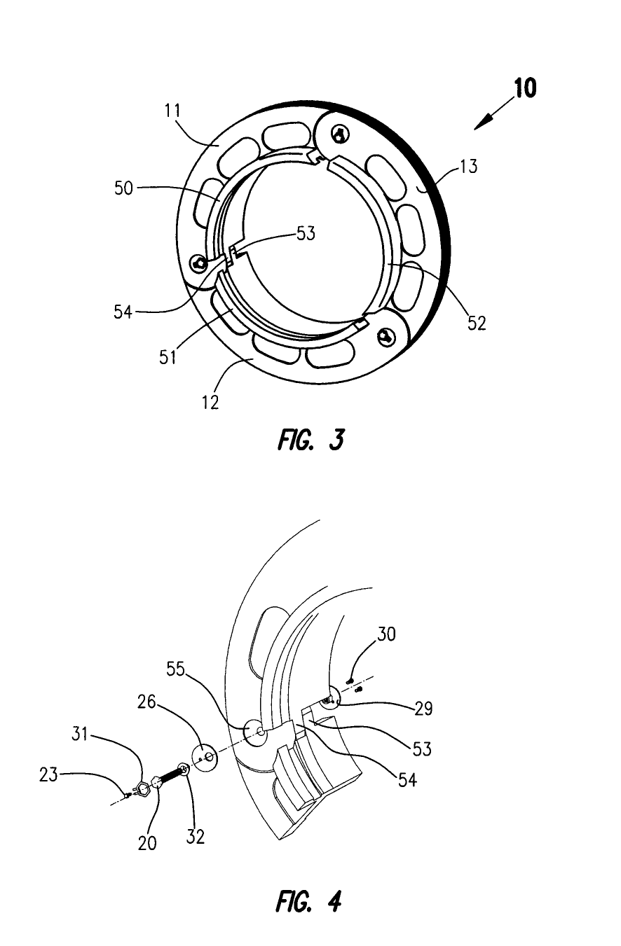

FIG. 2 is a cross-sectional view of the run flat device illustrated in FIG. 1, which illustrates a bolt 20 and screw 23, as well as a threaded nut portion 29 which accepts the bolt 20 and a screw 30 which holds the nut portion in place. FIG. 2 further illustrates a cross-section of two corresponding extended lip portions 50, 50A which are configured so as to abut corresponding tire beads which in turn abut corresponding wheel flanges thereby limiting or preventing lateral movement. The invention is not limited to a run flat tire or system with extended lip portions (as described below, the invention is not limited to the specific details and representative embodiments shown and described herein). A washer portion 26 as well as a cross-section of the connecting portions 53,54 of the main body portion of two arcuate sections are also illustrated. One embodiment includes a channel 33 for an air valve in one or more arcuate sections.

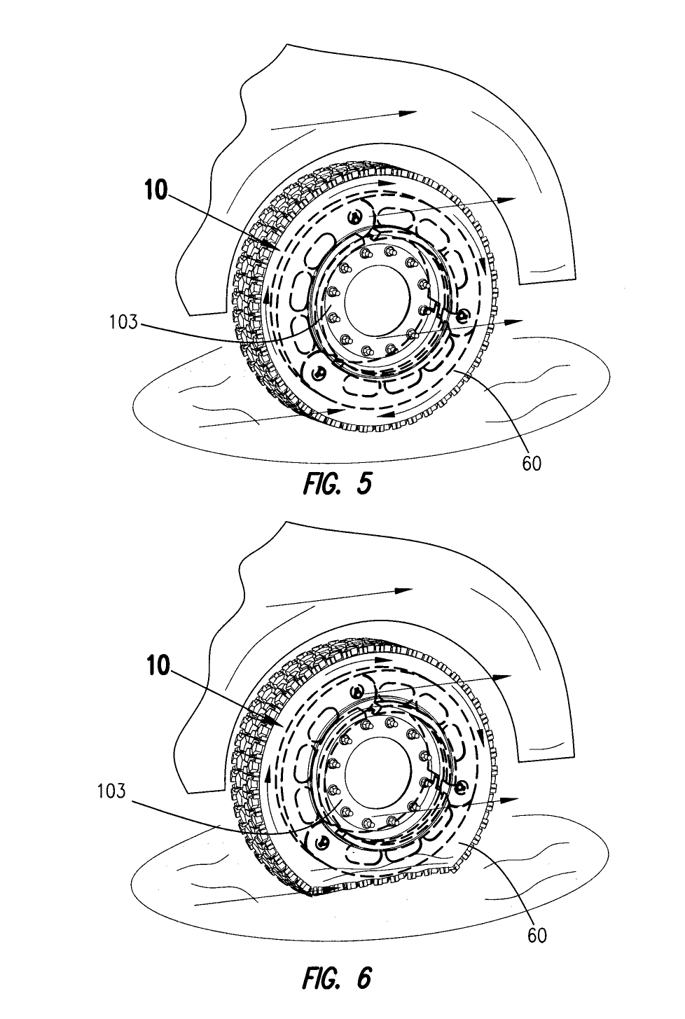

Referring now to FIG. 3, a perspective view of the run flat device 10 illustrated in FIG. 1 is shown. This figure illustrates extended lips 50, 51, 52, as well as the connecting portions 53, 54 of two adjacent arcuate sections 11, 12. FIG. 4 is an exploded view of the connecting area, in this embodiment, between two arcuate sections. A bolt 20 extends through a first washer 32, a second washer 26 and an opening in one of the arcuate sections. The washer 26 fits in a depression 55 in one arcuate section, and the bolt engages a hex locking clip 31 which is held in position by a screw 23. In this embodiment, the bolt extends through a threaded nut portion 29 which is held by one or more additional screws 30.

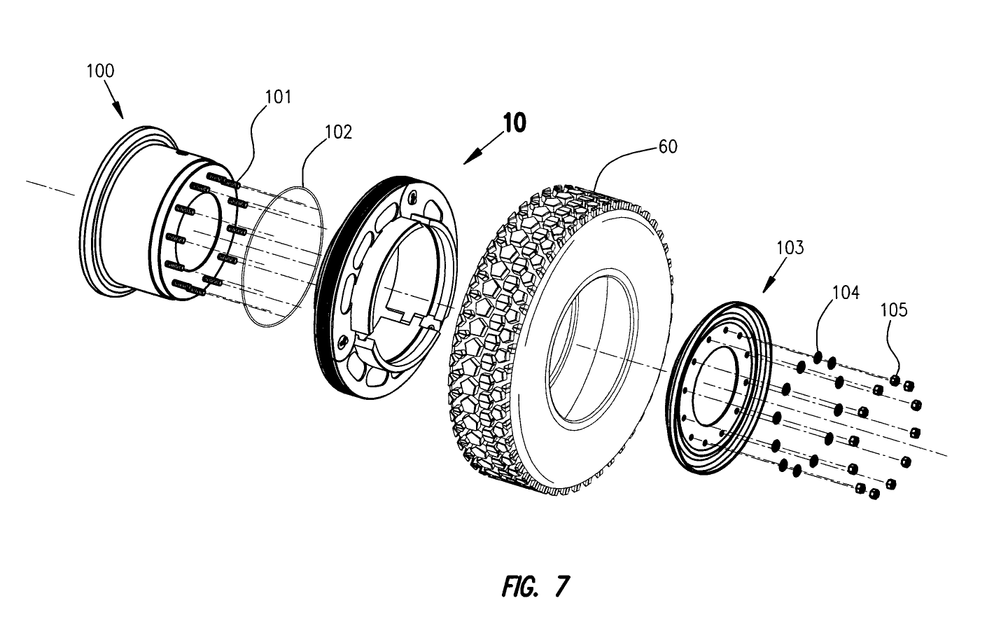

Referring now to FIG. 5, a run flat device 10 is shown (in dashed lines) as used with a wheel 103 and tire 60. FIG. 6 shows the operation of the run flat device 10 of FIG. 5 when the tire 60 is deflated. FIG. 7 is an exploded view of the run flat tire device 10, as connected to a two-piece wheel 103 and a tire 60. Tire bolts 101, a rubber ring 102 to seal the two halves 100, 103 of the wheel, washers 104 and nuts 105 are also depicted.

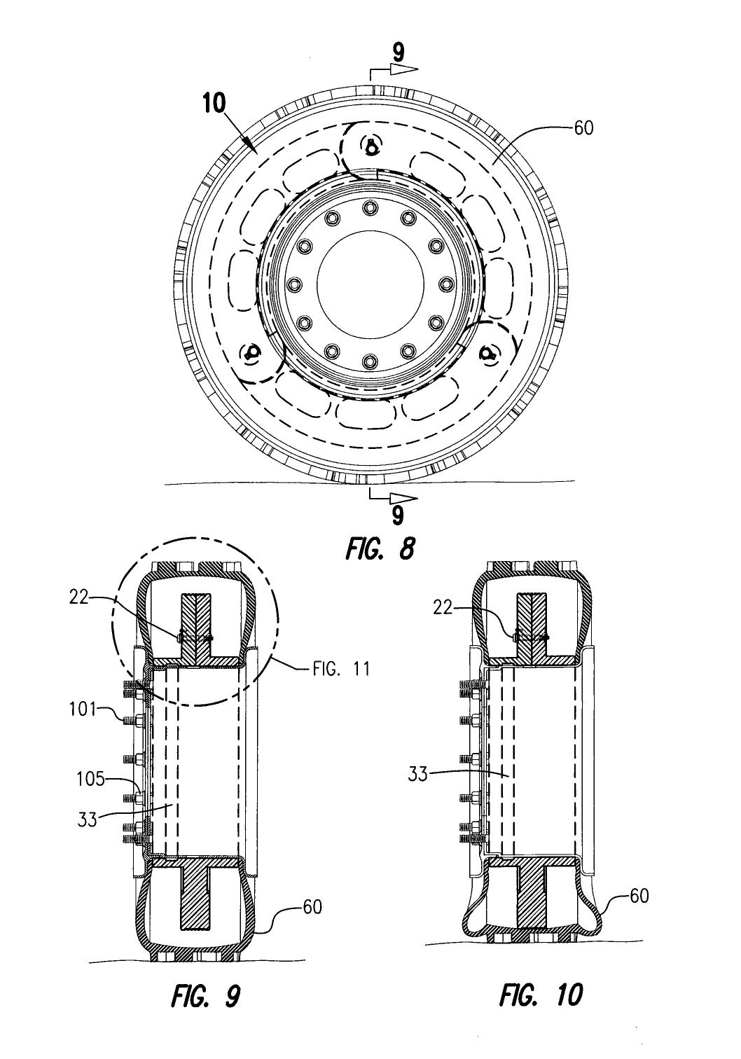

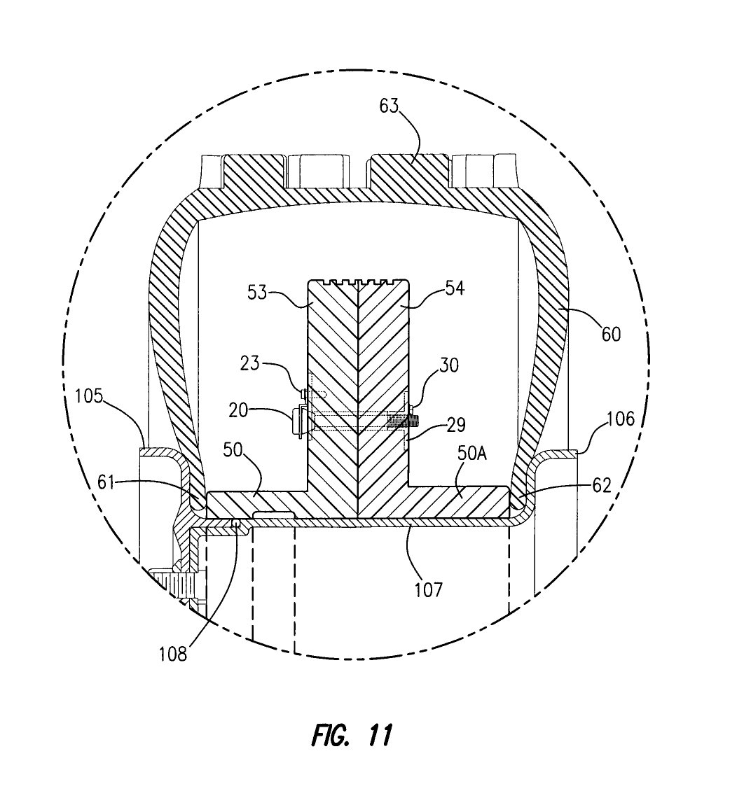

Referring now to FIG. 8, a run flat device 10 is shown (in dashed lines) as used inside a rubber tire 60. FIGS. 9 and 10 are cross-sectional views of the embodiment illustrated in FIG. 8, one with an inflated tire (FIG. 9) and one with a deflated tire (FIG. 10). In one embodiment, the main body portion of the arcuate sections extends about 75% of the height of the tire relative to the drop center of the wheel. The run flat tire and system, however, may comprise higher or lower profiles. FIGS. 9 and 10 also show an air valve channel 33. FIG. 11 is an expanded view of the cross-section illustrated in FIG. 9, which also illustrates tire treads 63, wheel flanges 105, 106 and tire beads 61, 62. In addition, FIG. 11 depicts the base or drop center 107 of the wheel, and an O-ring rubber seal 108, which may be used to seal a two-piece wheel. The invention may also be used with a multi-part wheel.

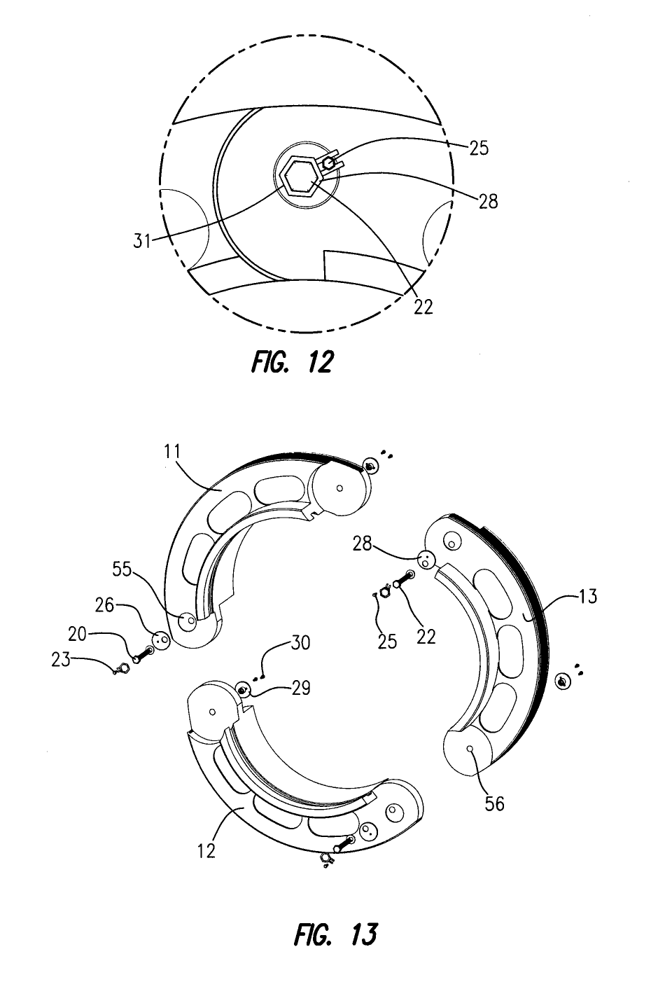

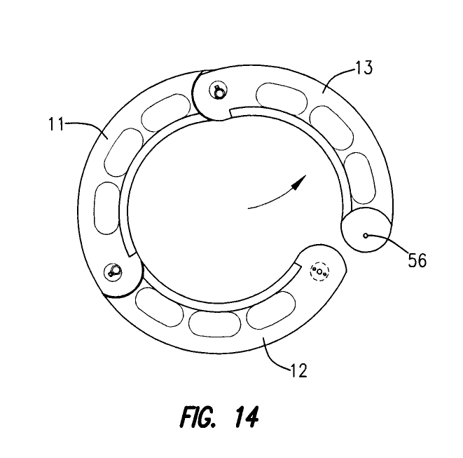

FIG. 12 is an expanded view of a portion of the connection assembly or connection area illustrated in FIG. 1, which illustrates a bolt 22, screw 25, washer 28 and hex locking clip 31. FIG. 13 is an exploded perspective view of a three-segment run flat device showing the various connection components described above. FIG. 14 is a side view of a run flat device which shows the motion of disconnecting one of the arcuate sections 13 from another 12, and an opening 56 in one section through which a bolt may be passed to secure the two adjacent/corresponding portions.

In one embodiment, three arcuate sections are assembled around the rim drop center of a tire, and may be configured and arranged to operate with high performance vehicles with central tire inflation systems (CTI). The inner circumference of the run flat device 10 may be designed and configured (by way of a mold fitted to the wheel or by machining, for example) so as to correspond to the profile of the wheel drop center to further reduce or eliminate lateral movement. In addition, the outer circumference of the run flat device, which comes into contact with a tire when the tire is deflated, may include a plurality of parallel circumferential channels or ribs, as shown at the top of the main body portion in the example illustrated in FIG. 11.

A method of installation of a run flat tire and system is described hereafter. First, a high temperature lubricant may be applied on the wall of a tire. Second, each arcuate section of the run flat tire device and system is inserted inside a tire. Another step of the installation process includes aligning the separate sections of the run flat device and system inside the tire and connecting such sections with nuts and bolts (or another mechanism for connection of aligned openings) in the respective sections of the run flat device. A further step is centering the run flat relative to the opening in the tire. The tire with run flat as assembled is placed over the bottom half of a wheel 100. The assembled parts are then pushed or pressed so that the bottom tire bead is seated against a wheel flange and the run flat device/system is located in the corresponding area in the wheel drop center. A further step includes tightening the nuts and bolts (or other hardware) in the run flat tire system. Finally, the top part 103 of the wheel corresponding to the bottom part is pressed into the opening of the run flat and against the surface of the bottom half of the wheel and secured.

The run flat tire and system may be manufactured through the use of a mold through an extrusion process (e.g. through a conventional or general purpose extruder), melt casting or injection molding, for example. Raw material in the form of plastic pellets, such as the material described in the previous paragraph, may be introduced into a hopper; thereafter, the plastic pellets may be heated and homogenized in an extruder until they become fluid enough to inject into a mold; whereupon the fluid plastic is pushed from the extruder by feed screws through a die and into a mold, where the material hardens.

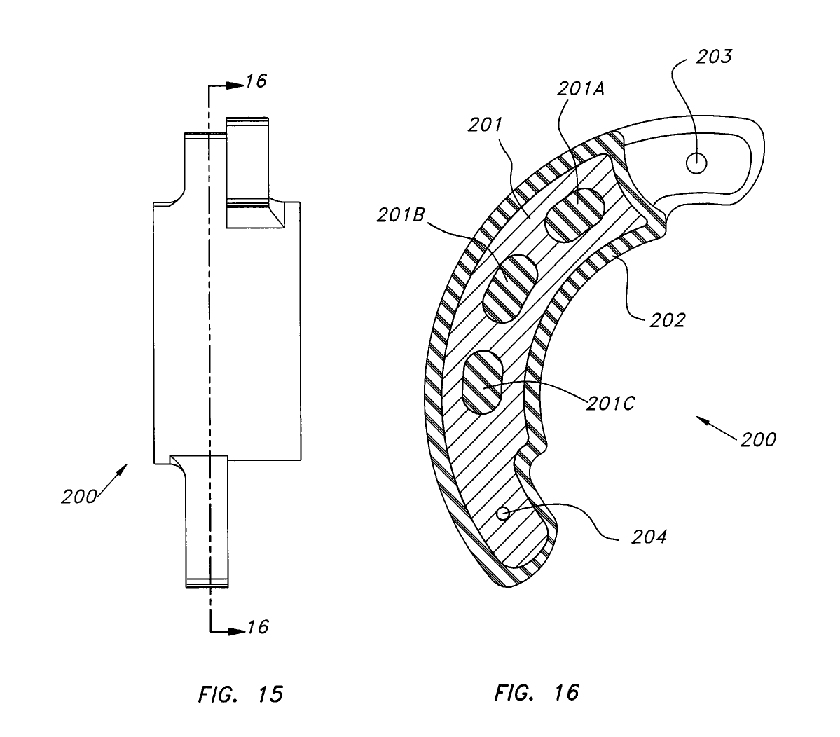

A preferred embodiment of the run flat tire and system comprises an insert or encapsulated portion made of a relatively strong and/or stiff material on the inside of (wholly or partially inside), or encapsulated by, a relatively soft material molded, formed or fitted on the outside of the insert portion, together forming a run flat segment or arcuate portion. Examples of such preferred embodiments are shown in FIGS. 15-21. In one aspect, the durometer, stiffness and/or strength of the outer portion is lower than that of the insert portion, or encapsulated portion. The relative softness/flexibility of the outer material may be configured and arranged to improve impact/shock absorption and/or flexibility, and the insert portion to provide strength/or and durability.

The configuration of the insert or encapsulated portion in this embodiment corresponds to or complements the design of the outer portion, the insert portion being located within, encompassed, surrounded or encapsulated by (in whole or in part) the outer portion. For example, the inner surface (relative to a wheel) of an insert portion may abut the wheel, with the remaining surfaces of the insert portion surrounded by an outer portion (e.g. the outer portion is molded around only the upper surfaces of an insert portion). As used herein, “encapsulated” includes any of the foregoing.

The insert or encapsulated portion may comprise DuPont Zytel® glass fiber reinforced polyamide 66 resin and/or DuPont Crastin® polybutylene terephthalate resin and/or steel such as 4140 steel. The outer portion may comprise a polyester elastomer thermoplastic resin such as Dupont PDHTR888860 or PDHTR863660.

Alternatively, the outer portion may comprise HYTREL 5556, HYTREL 7246, CRASTIN SK605 and CRASTIN ST820. In another embodiment, the foregoing materials are included in the following proportions: about 43% HYTREL 5556; about 15% HYTREL 7246; about 11% CRASTIN SK605; and about 31% CRASTIN ST820.

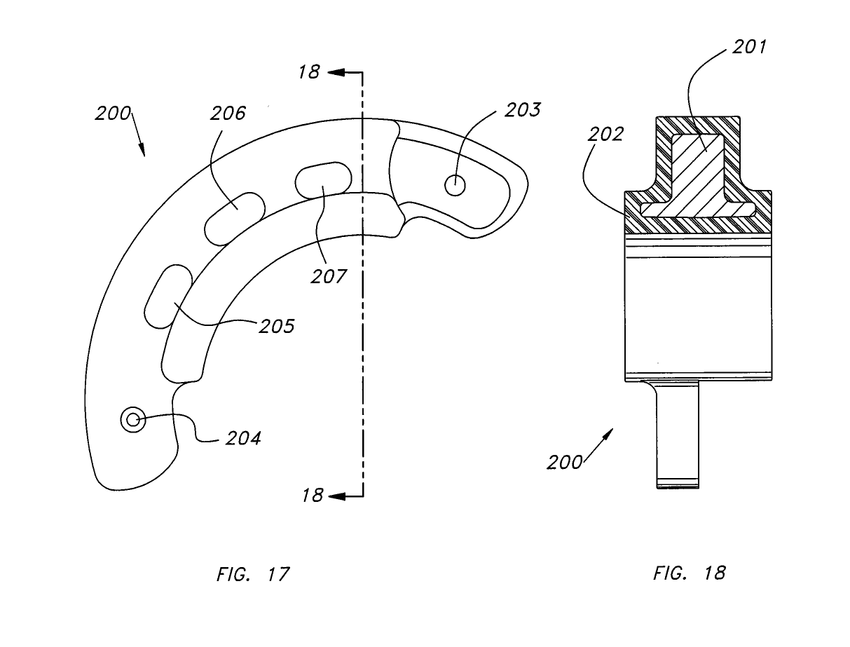

FIG. 15 is a side view of a run flat tire segment 200 with an insert portion, and FIG. 16 is a cross-sectional view of the run flat tire segment of FIG. 15 (along line 16-16). FIG. 16 further illustrates an insert portion 201 and corresponding outer portion 202; in this example, the insert portion defines or extends around both of the apertures or openings 203, 204 at the end of the segment. In other embodiments, the insert portion does not extend around or define such apertures/openings. In this illustration, the insert portion 201 includes three central apertures 201A, 201B, 201C; however, the run flat tire may be made with or without such apertures. The specific shapes of the insert portions shown in FIGS. 16-21 are exemplary in nature, and the insert portions may take various shapes, the insert portions being wholly or partially within an outer portion. FIG. 17 is another side view of the run flat tire segment of FIG. 15, and FIG. 18 is a cross-sectional view of FIG. 17 (along line 18-18). FIG. 18 illustrates the insert portion 201 surrounded or encapsulated by the outer portion 202 of the run flat tire segment.

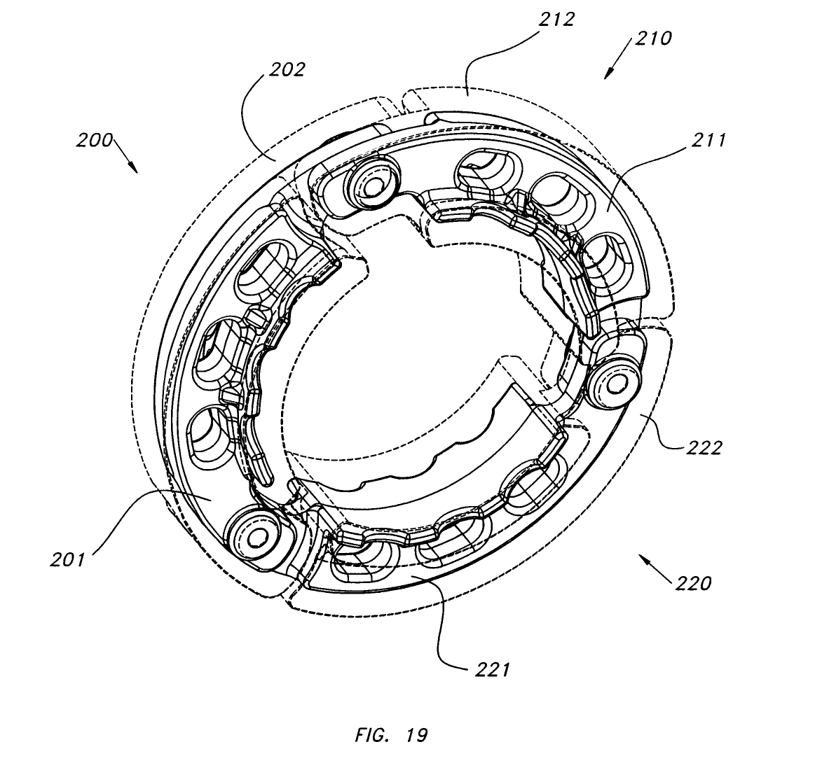

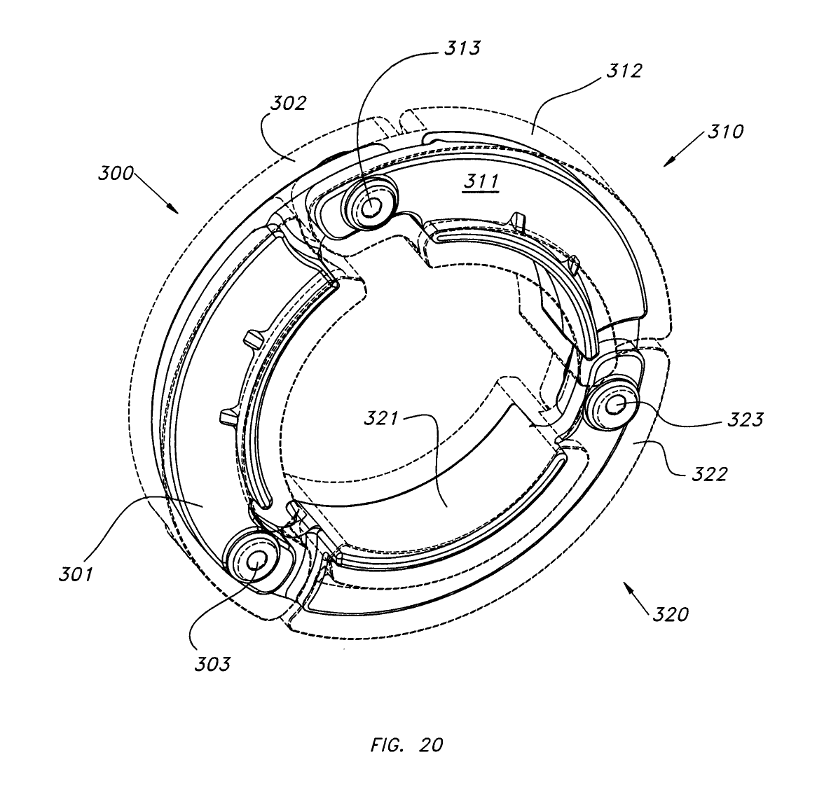

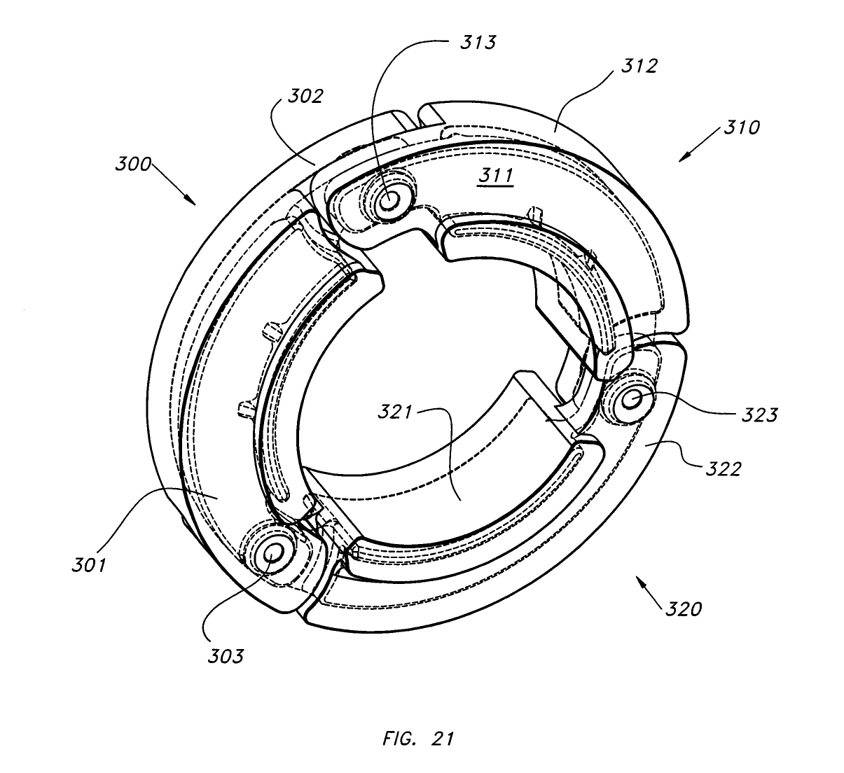

FIG. 19 is a perspective view of a three-segment run flat tire system with relatively stiff insert portions 201, 211, 221. Arcuate segments 200, 210, 220 are connected to form a ring or toroid for insertion in or around a wheel and inside a tire. In FIG. 19, the insert portions 201, 211, 221 of each arcuate segment include three central apertures. However, such central apertures are not required (as in the embodiments illustrated in FIGS. 20 and 21). FIG. 19 further illustrates the outer portion 202, 212, 222 (in dashed lines) of each arcuate segment. The arcuate segments in FIG. 19 (as well as FIGS. 20 and 21) may be connected using the hardware and materials described herein above, or by other suitable means. FIGS. 20 and 21 illustrate another preferred embodiment of the present invention having three arcuate segments 300, 310, 320 connected or joined (by aligning apertures 303, 313, 323 and corresponding apertures in adjacent arcuate segments) to form a ring or toroid. In this embodiment, central apertures within the stiff insert portions 301, 311, 321 have been eliminated. In FIG. 20, the relatively soft outer portions 302, 312, 322 are illustrated in dashed lines, and in FIG. 21 the same portions are illustrated in solid lines.

FIGS. 19-21 illustrate three arcuate sections 200, 210, 220 and 300, 310, 320 aligned as a continuous ring for installation around a tire; however, the invention is not limited to a run flat tire having three sections, but may have two sections or more than three sections.

The preferred embodiment with insert or encapsulated portion(s) may be manufactured by injection molding, melt casting or molding through an extrusion process (e.g. through a conventional or general purpose extruder) as described above. The insert portion is first made using one such technique; then, one method of manufacture provides that the insert portion is placed inside another mold, and the softer or less stiff or lower durometer material is molded around or directly onto the insert portion. Another method provides that the parts/portions are manufactured separately and fitted together. The embodiments illustrated in FIGS. 15 through 21 may be assembled and installed in the same manner as described above, or may be assembled and installed in a similar manner.

While there has been described what is believed to be a preferred embodiment of the present invention, those skilled in the art will recognize that other and further changes and modifications may be made thereto without departing from the spirit of the invention. Therefore, the invention is not limited to the specific details and representative embodiments shown and described herein. The terminology and phraseology used herein is for purposes of description and should not be regarded as limiting. Accordingly, persons skilled in this art will readily appreciate that various additional changes and modifications may be made without departing from the spirit or scope of the invention.

What is claimed is:

1. A run flat tire for use with a wheel having a drop center and a tire, comprising:
a plurality of complementary, load bearing arcuate portions each configured so as to extend radially outward from a wheel drop center;
wherein the inner peripheral surface of each of said arcuate portions is configured so as to abut the outer peripheral surface of said wheel drop center, and each of said arcuate portions is releasably secured to at least one other arcuate portion, and all of said arcuate portions form a continuous ring around said wheel; and
wherein each arcuate portion comprises: (a) an encapsulated portion, and (b) an outer portion encapsulating said encapsulated portion, wherein said encapsulated portion has greater strength than said outer portion.

2. The run flat tire of claim 1 wherein said encapsulated portion comprises reinforced polyamide 66 resin, polybutylene terephthalate resin, 4140 steel or steel.

3. The run flat tire of claim 1 wherein said outer portion comprises a polyester elastomer thermoplastic resin.

4. A run flat tire for use with a wheel having a drop center and a tire, comprising:
a plurality of complementary, load bearing arcuate portions each configured so as to extend radially outward from a wheel drop center;
wherein the inner peripheral surface of each of said arcuate portions is configured so as to abut the outer peripheral surface of said wheel drop center, and each of said arcuate portions is releasably secured to at least one other arcuate portion, and all of said arcuate portions form a continuous ring around said wheel; and
wherein each arcuate portion comprises: (a) an encapsulated portion, and (b) an outer portion encapsulating said encapsulated portion, wherein said encapsulated portion has a higher durometer than said outer portion.

5. The run flat tire of claim 4 wherein said encapsulated portion comprises reinforced polyamide 66 resin, polybutylene terephthalate resin, 4140 steel or steel.

6. The run flat tire of claim 4 wherein said outer portion comprises a polyester elastomer thermoplastic resin.

7. A method of making a run flat tire for use with a wheel having a drop center and a tire, comprising:
molding an insert portion from a resin in a first molding step in a first mold, said insert portion having a generally arcuate shape corresponding to the outer peripheral surface of said wheel drop center;
placing said insert portion in a second mold having a larger cavity than said first mold;
molding an outer portion from a thermoplastic material having lesser strength than said insert portion onto said insert portion such that said insert portion and said outer portion form an integral body that resists delamination during use; and
mounting said insert portion and said outer portion around a wheel drop center of a wheel such that said portions extend radially outward from said wheel drop center.

8. A method of making a run flat tire for use with a wheel having a drop center and a tire, comprising:
molding an insert portion from a resin in a first molding step in a first mold, said insert portion having a generally arcuate shape corresponding to the outer peripheral surface of said wheel drop center;
placing said insert portion in a second mold having a larger cavity than said first mold;
molding an outer portion from a thermoplastic material having a lower durometer than said insert portion onto said insert portion such that said insert portion and said outer portion form an integral body that resists delamination during use; and
mounting said insert portion and said outer portion around a wheel drop center of a wheel such that said portions extend radially outward from said wheel drop center.

9. A run flat tire system for use with a wheel having a wheel drop center and a tire, comprising:
a main body portion having a generally toroidal shape with an inner peripheral surface, said inner peripheral surface configured for alignment around a wheel drop center;
an insert portion encapsulated within said main body portion and extending through a substantial portion of said main body portion, said insert portion having greater strength than said main body portion;
wherein said inner peripheral surface of said main body portion abuts the outer peripheral surface of said wheel drop center.

10. The run flat tire system of claim 9 wherein said main body portion is softer than said insert portion.

11. The run flat tire system of claim 9 wherein said main body portion is more flexible than said insert portion.

12. The run flat tire system of claim 9 wherein said insert portion comprises reinforced polyamide 66 resin, polybutylene terephthalate resin, 4140 steel or steel.

13. The run flat tire system of claim 9 wherein said main body portion comprises a polyester elastomer thermoplastic resin.

14. A run flat tire system for use with a wheel having a wheel drop center and a tire, comprising:
a main body portion having a generally toroidal shape with an inner peripheral surface, said inner peripheral surface configured for alignment around a wheel drop center;
an insert portion encapsulated within said main body portion and extending through a substantial portion of said main body portion, said insert portion having greater durometer than said main body portion;
wherein said inner peripheral surface of said main body portion abuts the outer peripheral surface of said wheel drop center.

15. The run flat tire system of claim 14 wherein said main body portion is more flexible than said insert portion.

16. The run flat tire system of claim 14 wherein said insert portion comprises reinforced polyamide 66 resin, polybutylene terephthalate resin, 4140 steel or steel.

17. The run flat tire system of claim 14 wherein said main body portion comprises a polyester elastomer thermoplastic resin.
